(19) United States
(12) Patent Application Publication
(10) Pub. No.: US 2026/0209459 A1
(43) Pub. Date: Jul. 23, 2026

(54) ULTRALOW-RI MATERIALS, LOW-K DIELECTRIC MATERIALS, COMPOSITES, AND METHODS

(71) Applicant: Brewer Science, Inc., Rolla, MO (US)

(72) Inventors: Reuben T. Chacko, Rolla, MO (US); Stephen R. Murphy, Rolla, MO (US); Robert C. Cox, Osage Beach, MO (US); Matthew J. Kindhart, St. Robert, MO (US); Madison R. Brophy, St. Robert, MO (US)

(21) Appl. No.: 19/456,118

(22) Filed: Jan. 22, 2026

Related U.S. Application Data
(60) Provisional application No. 63/748,404, filed on Jan. 22, 2025.

(51) Int. Cl. C08J 9/26; C08G 77/00; C08G 77/04; C08G 77/18; C09D 183/04; C09D 183/06

(52) U.S. Cl. CPC C08J 9/26; C08G 77/04; C08G 77/18; C09D 183/04; C09D 183/06; C08G 77/80; C08J 2201/0424; C08J 2201/0444; C08J 2383/04; C08J 2383/06

(57) ABSTRACT

A composition for use in forming low-refractive-index layers includes a siloxane polymer, a porogen, and a curing catalyst that is different from the porogen. The composition can be processed at low temperatures of less than about 125° C. (e.g., about 70-90° C.) to crosslink the polymer. The crosslinked material can be exposed to a developer (e.g., acetone) to remove the porogen, thus forming a low-refractive-index film (e.g., less than about 1.3). A method of forming a nanoporous structure includes applying a composition including a siloxane polymer and a porogen to a substrate. The composition optionally includes a curing catalyst different from the porogen. The siloxane polymer is crosslinked and then contacted with a developer so as to remove the porogen and form pores in the crosslinked composition to yield the nanoporous structure.

### CROSS-REFERENCE TO RELATED APPLICATIONS

The present application claims the priority benefit of U.S. Provisional Patent Application Ser. No. 63/748,404, filed Jan. 22, 2025, entitled ULTRALOW-RI MATERIALS, LOW-K DIELECTRIC MATERIALS, COMPOSITES, AND METHODS, the entirety of which is incorporated by reference herein.

### BACKGROUND

### Field

The present disclosure relates generally to low-refractive-index and low-k dielectric materials and methods, and more particularly to silicon-containing, film-forming compositions and methods suitable for forming coatings having a refractive index of about 1.3 and even lower.

### Description of Related Art

Low-refractive-index (RI) materials are needed for silicon photonics, augmented reality (AU), virtual reality (VR), near-eye display (NED) devices, optical coatings, CMOS image sensors (CIS), and micro-OLED applications. Low-RI materials can also be combined with high-RI materials to make antireflective coatings and optical waveguides.

Optical waveguides are important in many structures for isolating and directing light from a source to a target. The higher the difference in refractive index between the light-directing high-RI material and the low-RI cladding material, the better the isolation of light from source to target. Like optical fibers, waveguides operate through total internal reflection (TIR) to direct light. NEDs have core cladding structures to direct light, and low-RI materials allow for tighter turns with waveguides as well as better optical isolation. In CIS devices, low-RI materials are used for optical isolation of red, green, blue (RGB) cells as well as for antireflective applications as coats on lenses.

One way to design a composition for forming a film having a low refractive index is to incorporate porogens into the material. Porogens refer to components that result in high porosity in the resulting film. One type of porogen is a nanoparticle that is removable by pyrolysis, meaning the film is baked at a temperature above the thermal decomposition temperature of the particle, leaving voids in the film. This method often results in particles remaining in the voids, which is undesirable in many applications.

Another option is to use nanophase separation of components in a blended matrix into different nanodomains where one of the phase-separated domains is removable. Unfortunately, the polymeric materials used are not wear-resistant and are not suitable for many applications requiring reliability and long-term durability.

Compositions that can form low-refractive-index films suffer from other limitations as well, including the need for processing at relatively high temperatures that are incompatible with structures on which it would be desirable to apply the material. This constraint undesirably limits the range of devices into which the materials can be integrated. For example, it may be desirable to apply a low-refractive-index coating to a polymeric substrate that cannot withstand higher temperature processing. Likewise, it may be desirable to apply a low-refractive-index coating over the top of a substrate including delicate microelectronic device structures. Another limitation is the inability to achieve a refractive index that is as low as is desired. A further limitation is that some low-refractive-index film-forming compositions are not as easily applied to the target substrate as desired, especially at the desired thickness and with desired thickness uniformity. It is also desirable for a low-refractive-index film to have high transmittance (e.g., >95% at specified wavelengths) and to avoid yellowing over time (e.g., after prolonged exposure to heat, high humidity, and sunlight). Low durability of the resulting film is another concern with some prior art low-refractive-index, film-forming compositions.

Yet another concern is the shelf-life stability of the film-forming composition. Some film-forming compositions that provide a desirable performance profile across a combination of criteria only do so for a short time after synthesis, with the ability to achieve the desired performance falling off after an undesirably brief time on the shelf. These limitations present various trade-offs. It is often the case that a film-forming composition that performs relatively well with respect to one or more of these criteria performs much worse in one or more others, thereby limiting applicability of that composition.

Additionally, some prior art low-refractive-index film-forming compositions use per- or polyfluoroalkyl substance (PFAS)-containing materials. However, these PFAS-containing materials are undesirable due to growing environmental concerns and related regulatory restrictions. Thus, in addition to finding a desirable balance of the trade-offs in the performance criteria, it is also now desirable, if not required, to be able to do so without using any PFAS-containing materials.

Low-k dielectric materials are also very much in need in the semiconductor industry for use in a wide variety of electronic applications. Materials having low refractive indices are typically also low-k dielectric materials because the two properties are related.

### SUMMARY

The disclosure broadly provides a method of forming a nanoporous structure. The method comprises applying a composition to a substrate, with the composition comprising a siloxane polymer and a porogen. The siloxane polymer is crosslinked to form a crosslinked composition, and a developer is contacted with the crosslinked composition so as to remove the porogen and form pores in the crosslinked composition to yield the nanoporous structure.

In another embodiment, the disclosure provides a composition comprising a siloxane polymer, a porogen, and a curing catalyst that is different from the porogen.

### BRIEF DESCRIPTION OF THE DRAWINGS

FIG. 1 is a scanning electron microscope (SEM) image (200 kX) of the cross-section of a film on silicon after a 70° C. bake for 5 minutes (Example 3);

FIG. 2 is a graph showing the refractive index of a film on silicon after a 70° C. bake for 5 minutes (Example 3);

FIG. 3 is an SEM image (100 kX) of the cross-section of a film on silicon after a 70° C. bake for 5 minutes, followed by a 5-minute acetone rinse, and then an additional bake at 70° C. for 5 minutes (Example 3);

FIG. 4 is a graph of the refractive index of a film after a 70° C. bake for 5 minutes, followed by a 5-minute acetone rinse, and then an additional bake at 70° C. for 5 minutes (Example 3);

FIG. 5 is a graph of the refractive index of a film after a 70° C. bake for 5 minutes, followed by a 1-day wait, a 5-minute reagent alcohol rinse, and then an additional bake at 70° C. for 5 minutes (Example 3);

FIG. 6 is a graph of the refractive index of a film after a 70° C. bake for 5 minutes, followed by a 1-day wait, and then a 5-minute bake at 90° C. (Example 3);

FIG. 7 is a graph of the refractive index of a film after a 70° C. bake for 5 minutes, followed by a 1-day wait, and then a 5-minute bake at 90° C., a rinse with acetone for 5 minutes, and finally a bake at 90° C. for 1 minute (Example 3);

FIG. 8 is a graph of the refractive index of a film after a 70° C. bake for 5 minutes, followed by a 1-day wait, and then a 5-minute bake at 90° C., a rinse with reagent alcohol for 5 minutes, and finally a bake at 90° C. for 5 minutes (Example 3);

FIG. 9 is a graph of the refractive index of a film after a 70° C. bake for 5 minutes, followed by rinsing with reagent alcohol for 5 minutes, re-spinning, and a second bake at 70° C. for 5 minutes (Example 10);

FIG. 10 is a graph showing the transmission of a 90° C.-processed, low-RI film with a transmission of >99% on glass (Example 13);

FIG. 11(A) is an SEM image (200 kX) of a cross-section of a substrate processed at 70° C. (Example 16);

FIG. 11(B) is an SEM image (200 kX) of a cross-section of a substrate processed at 90° C. (Example 16);

FIG. 12 is an SEM image (100 kX) of a cross-section of a substrate processed at 90° C. (Example 16);

FIG. 13 is a graph showing the refractive index of a low-temperature-processed, low-RI material before and after testing as described in Example 19;

FIG. 14(A) is an SEM image (200 kX) of a cross-section of a wafer showing the gap fill properties of the Example 21 formulation in dense vias (Example 22);

FIG. 14(B) is an SEM image (200 kX) of a cross-section of a wafer showing the gap fill properties of the Example 21 formulation in semi-dense vias (Example 22);

FIG. 15 is a graph showing the refractive index of the Example 21 formulation after the use of a cyclohexanone rinse (Example 23); and

FIG. 16 is a graph showing the minimal change in optical properties of the Example 21 formulation after testing under high-temperature, high-humidity conditions as described in Example 24.

### DETAILED DESCRIPTION

The present disclosure is concerned with compositions and methods for forming low-RI films or layers. The compositions comprise a siloxane polymer, a porogen, and preferably a curing catalyst different from the porogen dispersed or dissolved in a solvent system. The methods include applying a composition including a siloxane polymer and a porogen to a substrate, crosslinking the siloxane polymer, and then using a developer to remove the porogen, resulting in a porous low-RI film or layer.

### Compositions

### 1. Siloxane Polymer

Suitable siloxane polymers are crosslinkable and can be formed from a variety of silane monomers. In some embodiments, the siloxane polymer is a homopolymer. In other embodiments, the siloxane polymer comprises two or more monomers. Examples of suitable monomers include those monomers chosen from alkoxy silanes (particularly C₁-C₄ alkoxy silanes), phenyltrimethoxysilane (“PTMS”), methacryloxypropyltrimethoxysilane, tetramethylorthosilicate (“TMOS”), methyltriethoxysilane (“MTEOS”), dimethyldimethoxysilane (“DMDMS”), dimethyldiethoxysilane (“DMDEOS”), 2-(3,4-epoxycyclohexyl)ethyltrimethoxysilane (“ECHETMS”), methyltrimethoxysilane (“MTMS”), tetraethoxysilane (“TEOS”), acryloxypropyltrimethoxysilane, 3-glycidyloxypropyltrimethoxysilane (“GlyTMS”), phenethyltrimethoxysilane (“PETMS”), 2-(carbomethoxy)ethyltrimethoxysilane (“CMETMS”), acetoxyethyltrimethoxysilane, ethyltrimethoxysilane (“ETMS”), n-butyltrimethoxysilane (“BuTMS”), 5,6-epoxyhexyltriethoxysilane (“EPOTEOS”), silanes with quaternary ammonium salts (e.g., n-trimethoxysilylpropyl-n,n,n-trimethylammonium halide), or combinations thereof.

In one or more embodiments, exemplary polysiloxanes for these applications include those that can be crosslinked, such as polydimethylsiloxane (“PDMS”), polymethylhydrosiloxane, or poly(dimethylsiloxane-co-methylhydrosiloxane) copolymers, with terminal or branching functional groups such as vinyl and hydrosilanes cured with karstedt catalyst.

In some embodiments, the siloxane polymer consists essentially of, or even consists of, siloxane monomers.

The siloxane polymer may be synthesized using a sol-gel reaction by dissolving the desired monomers as described above in an appropriate polymerization solvent. Polymerization solvents may include, but are not limited to, propylene glycol monomethyl ether acetate (“PGMEA”), propylene glycol methyl ether (“PGME”), propylene glycol ethyl ether (“PGEE”), cyclohexanone, ethyl lactate, propanol, butanol, or mixtures thereof. Suitable catalysts include, but are not limited to, mineral acids (such as hydrochloric acid or nitric acid), acetic acid, or combinations thereof. The hydrolysis is preferably allowed to begin at room temperature, and the hydrolyzed monomers are then polymerized at a temperature of about 40° C. to about 120° C., preferably about 100° C. to about 115° C., and more preferably about 60° C. to about 100° C., for a time period of about 0.5 hours to about 72 hours, preferably about 1 hour to about 48 hours, and more preferably about 5 hours to about 16 hours. The weight-average molecular weight (Mw) of the polymer as measured by gel permeation chromatography (GPC) is preferably about 500 g/mol to about 50,000 g/mol, more preferably about 1,000 g/mol to about 5,000 g/mol, and even more preferably about 1,000 g/mol to about 3,000 g/mol.

In some embodiments, it is desirable that the siloxane polymer crosslinks upon exposure to UV light (i.e., light having a wavelength of about 100 nm to about 400 nm). In these embodiments, the siloxane polymer contains one or more silane monomers functionalized with UV curable groups, such as ethylenically unsaturated groups including an alkylene group, an oxyalkylene group, an alkylene aryl (preferably C₆) group, an alkenylene group, an oxyalkenylene group, an alkynylene group, an alkenylene aryl group, an acrylate group, a methacrylate group, or a combination thereof. The alkyl moieties in the foregoing monomers are typically C₁ to C₁₀ and preferably C₁ to C₆.

### 2. Porogens

Suitable porogens are nanodomain-forming porogens. That is, it is preferred that the selected porogen is one that will form segregated nanodomains within the crosslinked siloxane polymer, with those nanodomains being developable (removable) upon contact with a developer to remove the porogen. Thus, the porogen is preferably selected to be soluble in developers such as those chosen from ketones (e.g., acetone, cyclohexanone), alcohols (e.g., ethanol, reagent alcohol, isopropyl alcohol, butanol, propanol), tetramethylammonium hydroxide, n-butyl acetate, propylene glycol methyl ether, propylene glycol methyl ether acetate, or mixtures thereof. As used herein, a porogen is soluble in a developer if that porogen is about 95% or more, preferably about 98% or more, and more preferably about 100% removed and/or dissolved by that developer within about 7 minutes or less, and preferably within about 5 minutes or less, of being submerged into that developer at ambient temperatures (i.e., about 20° C. to about 25° C.).

In some embodiments, the preferred porogen is a salt that is soluble in the chosen developer. Examples of suitable salts include those chosen from ammonium salts, phosphonium salts, pyridinium salts, sulfonium salts, chloride salts (e.g., CaCl₂)), or combinations thereof.

Suitable ammonium salts include quaternary ammonium salts, including quaternary arylammonium salts and quaternary alkylammonium salts. Suitable quaternary arylammonium salts include, for example, C₆ to C₁₂ aryls, with quaternary ammonium benzoates being one such example. Exemplary quaternary alkylammonium salts include quaternary alkylammonium acetates, quaternary alkylammonium formates, quaternary alkylammonium tosylates, quaternary alkylammonium mesylates, quaternary alkylammonium nitrates, quaternary alkylammonium phenoxides, quaternary alkylammonium acetylacetonates, and/or quaternary alkylammonium halides. The alkyl groups present on the quaternary alkylammonium salts are preferably individually chosen from C₁ to C₇ alkyl groups. Suitable halides for use in the quaternary ammonium salts include those chosen from iodide, fluoride, chloride, and/or bromide. Tetrabutylammonium salts are particularly well-suited for use herein, with tetrabuylammonium iodide, tetrabutylammonium acetate, tetrahexylammonium iodide, and/or tetrabutylammonium formate being preferred examples. Other suitable salts include choline iodide, tetrabutylphosphonium bromide, ethyltriphenylphosphonium bromide, or combinations thereof.

In another embodiment, the nanodomain-forming porogen comprises a nanodomain-forming polymer. Suitable nanodomain-forming polymers include poly(alkylene oxides) (preferably C₂ to C₆, e.g., poly(ethylene glycol)), block copolymers (e.g., block copolymers of ethylene glycol, propylene glycol, butylene glycol, and/or alkylated alternatives of these species), polyacrylic acid and/or salts thereof, methacrylic acid and/or salts thereof, polysulphonic acids and/or salts thereof, polyethylene imine and/or salts thereof, and/or combinations thereof.

### 3. Curing Catalyst

Although not required, in some embodiments the composition includes one or more curing catalysts. When included, suitable curing catalysts are selected to be different from the porogen. Examples of suitable curing catalysts include those chosen from ammonium salts, phosphonium salts, silanes containing basic amine or imidazole groups (e.g., triethoxy-3-(2-imidazolin-1-yl) propylsilane), formate salts, acetate salts, or combinations thereof. Preferred curing catalysts are chosen from tetrabutylammonium fluoride, tetrabutylammonium acetate, tetrabutylammonium iodide, tetrahexylammonium iodide, benzyltriethylammonium chloride, tetrabutylphosphonium bromide, ethyltriphenylphosphonium bromide, choline iodide, thermal acid generators (TAGs), photo acid generators (PAGs), radical initiators, or combinations thereof.

### 3. Solvent System

The solvent system can comprise one or more solvents, with organic solvents being preferred. Examples of solvents that can be used in the composition include those chosen from alcohols (e.g., methanol, ethanol), PGMEA, PGME, PGEE, dimethylsulfoxide (“DMSO”), propylene glycol n-propyl ether (“PnP”), ethyl lactate, cyclohexanone, gamma-butyrolactone (“GBL”), methyl isobutyl carbinol 3-methyl-1,5-pentanediol, 1,2-propylene glycol, 1,3-propylene glycol, ethylene glycol, cyclopentanone, or mixtures thereof.

### 4. Composition Preparation

The siloxane polymer, porogen, curing catalyst (if included), and any additives are dispersed or dissolved in the solvent system to form the composition, preferably by mixing or stirring. The solvent system is preferably utilized at a level of about 10% to about 90%, and more preferably about 65% to about 75% by weight, based upon the total weight of the composition taken as 100% by weight, with the balance of the composition being solid(s). Typical total solids contents of the compositions range from about 10% to about 90% by weight, preferably from about 25% to about 55% by weight, and more preferably from about 30% to about 45% by weight, based upon the total weight of the composition taken as 100% by weight, with the balance of the composition being solvent(s).

The siloxane polymer is typically included in the composition at a level of about 10% to about 30% by weight, and more preferably about 15% to about 25% by weight, based upon the total weight of the composition taken as 100% by weight. The porogen is typically included at a level of about 5% to about 20%, and more preferably about 10% to about 15% by weight, based upon the total weight of the composition taken as 100% by weight. In some embodiments, the weight ratio of siloxane polymer to porogen is about 1:0.5 to about 1:3, and more preferably about 1:1 to about 1:2.

In embodiments where a curing catalyst is included, the curing catalyst is different from the porogen. In these embodiments, that curing catalyst is preferably included at a level of about 1% to about 20% by weight, and more preferably about 5% to about 10% by weight, based on the weight of the polymer solids taken as 100% by weight. In one or more embodiments, the weight ratio of porogen to curing catalyst is about 30:1 to about 1:1, preferably about 25:1 to about 10:1, and more preferably about 25:1 to about 20:1.

Suitable additives include surfactants, additives to improve spin bowl compatibility and drain compatibility, crosslinking species or catalysts to induce crosslinking, curing agents, or combinations thereof. In some embodiments, additives may be used to improve spin bowl and drain compatibility. In these embodiments, suitable additives include, but are not limited to, adipic acid, maleic acid, or combinations thereof.

Alternatively, in some embodiments, no curing catalyst and no crosslinking catalysts are required. In these embodiments, the composition comprises less than about 0.05% by weight, preferably less than about 0.01% by weight, and more preferably about 0% by weight total of curing and crosslinking catalysts, based upon the total weight of the solids in the composition taken as 100% by weight.

The composition is preferably substantially free of PFAS. That is, the composition contains less than about 0.01% by weight PFAS, preferably less than about 0.001% by weight PFAS, and more preferably about 0% PFAS, based upon the total weight of the composition taken as 100% by weight. For example, there are no PFAS-containing materials present other than perhaps unavoidable contamination in the most preferred embodiments. As used herein, “PFAS” refers to a compound that includes an alkyl having two or more fluorine atoms bonded to the same carbon atom.

In one or more embodiments, the composition is essentially free of nanoparticles. In such embodiments, the composition contains less than about 0.01% by weight, preferably less than about 0.001% by weight, and more preferably about 0% by weight nanoparticles, based upon the total weight of the solids in the composition taken as 100% by weight. As used herein, nanoparticles refer to those particles having an average particle size of about 100 nm or lower, preferably about 50 nm or lower, and preferably about 10 nm or lower. Examples of nanoparticles that would not be present include one or more of boron nitride nanoparticles, silica nanoparticles, ultra-high molecular weight polyethylene (UHMWPE) nanoparticles, polystyrene nanoparticles, and/or metal-organic framework nanoparticles.

In some embodiments, the composition is essentially free of surfactants having alkyl chains of C₁₀ or longer, and preferably of C₈ or longer. In such embodiments, the composition contains less than about 0.01% by weight, preferably less than about 0.001% by weight, and more preferably about 0% of such surfactants, based upon the total weight of the solids in the composition taken as 100% by weight.

In one or more embodiments, the composition is essentially free of “free silanes” (i.e., silanes that are not part of the siloxane polymer). In such embodiments, the composition contains less than about 0.01% by weight, preferably less than about 0.001% by weight, and more preferably about 0% free silanes, based upon the total weight of the solids in the composition taken as 100% by weight.

In one or more embodiments, the composition is essentially free of cyclodextrin. In such embodiments, the composition contains less than about 0.01% by weight, preferably less than about 0.001% by weight, and more preferably about 0% free cyclodextrin, based upon the total weight of the solids in the composition taken as 100% by weight.

In one or more embodiments, the composition is essentially free of urea. In such embodiments, the composition contains less than about 0.01% by weight, preferably less than about 0.001% by weight, and more preferably about 0% urea, based upon the total weight of the solids in the composition taken as 100% by weight.

In some embodiments, the composition consists essentially of, or even consists of, the siloxane polymer, porogen, and solvent system.

In other embodiments, the composition consists essentially of, or even consists of, the siloxane polymer, porogen, curing catalyst, and solvent system.

### Methods of Use

The compositions described above can be formed into a film or other structure by applying to a substrate or other surface where a low-RI film or other structure is needed. As used herein, “film” is used interchangeably with “coating” or “layer,” unless otherwise specified, and “structure” is intended to refer to shapes not encompassed by film, and includes lines, wires, squares, monolithic structures, etc.

This applying can be accomplished via any number of methods, including spin coating, dip coating, inkjet printing, roller coating, slot coating, die coating, screen printing, draw-down coating, jetting, molding, additive manufacturing, or spray coating. One method involves spin coating the composition at speeds of about 500 rpm to about 3,000 rpm, and preferably about 1,000 rpm to about 1,500 rpm, for a time period of about 20 seconds to about 60 seconds, and preferably about 30 seconds to about 40 seconds. Another method involves dip coating using a conventional dipcoater. Typical dipping rates vary from about 1 mm/sec to about 10 mm/sec.

The substrate on which the nanoporous low-RI film or other structure described herein can be formed includes any substrate where that film or structure type is needed, including in the formation of various microelectronic devices. For example, the nanoporous low-RI films or other structure formed by these methods can be used in a back side illumination complementary metal oxide semiconductor (CMOS) image sensor, as a gap fill material, in color filters, between photodiodes, for waveguide applications, conformally on a microlens, and/or on cover as an antireflective coating. Thus, the substrate can be silicon, glass, polycarbonate, one or more microlenses, a lens body, patterned substrates, silicon nitride, high-RI substrates (e.g., RI about 1.6 or higher), poly(methyl methacrylate) (PMMA), and/or other device structure.

In some embodiments, the low-RI composition may be placed in storage for a period of time after the sol-gel polymer and porogen are combined to produce the composition. For example, the period of time between the time the composition is produced and the application to a substrate can be a one week or longer, about 4 weeks or longer, about 6 weeks or longer, or even about 10 weeks longer. The length of this time may correlate to shelf-life, spin bowl time, and/or queue time. Thus, in some preferred embodiments the method includes storing an embodiment comprising, for example, tetrabutylammonium iodide for a period of time between the time the composition is produced and the application to the substrate of about one week or longer, about 4 weeks or longer, about 6 weeks or longer, or even about 10 weeks longer.

Regardless of the application method, the siloxane polymer in the applied/shaped composition is then crosslinked to form a crosslinked composition. In some embodiments, this involves heating the composition to a temperature that is about 125° C. or lower, preferably about 90° C. or lower, and more preferably about 70° C. or lower. With each of the foregoing ranges, the lowest heating temperature is typically about 60° C. or 70° C. Typical time periods of heating are about 1 second to about 6 minutes, and more preferably about 60 seconds to about 4 minutes.

In some embodiments crosslinking is effected by exposing the composition to UV radiation (i.e., light having a wavelength of about 100 nm to about 400 nm).

Regardless of the crosslinking mechanism, that mechanism causes the siloxane polymer to crosslink, as noted above. Additionally, because the porogen molecules are substantially intermixed and/or interspersed among the polymer chains in the composition, the same is true during crosslinking. As a result, the porogen molecules form a plurality of nanodomains embedded and/or interspersed in and among the crosslinked polymer network or matrix that is formed.

After crosslinking, the crosslinked composition is contacted with a developer (selected as described previously) to remove the porogen from the porogen-containing nanodomains, leaving behind voids or pores in the crosslinked composition. Preferably, the developer is not a supercritical fluid, nor does it comprise a supercritical fluid such as supercritical CO₂. In the same or different embodiments, the developer comprises less than about 5% by weight water, preferably less than about 1% by weight water, more preferably less than about 0.5% by weight water, and even more preferably about 0% by weigh water.

The average pore diameter of the crosslinked composition is about 0.5 nm to about 100 nm, preferably about 0.5 nm to about 50 nm, more preferably about 1 nm to about 30 nm, and even more preferably about 1 nm to about 15 nm. Pore diameter can be determined by viewing a cross-section of the crosslinked composition under a scanning electron microscope at a magnification of at least 200 kX, measuring the largest pore dimension of the pore visible in the cross-section, and determining the average of the measurements. In one or more embodiments, the average pore volume of the crosslinked composition is about 0.2 cm³/g to about 20 cm³/g, preferably about 0.65 cm³/g to about 10 cm³/g, and more preferably about 1 cm³/g to about 2.5 cm³/g. Average pore volume can be determined by a number of techniques, including nitrogen absorption-desorption methods, such as the Barrett-Joyner-Halenda (BJH) or Brunauer-Emmett-Teller (BET) methods.

In instances where the composition is in the shape of a layer, this developing results in the formation of an ultralow-RI film. In instances of using the composition as a gap fill material, the composition is applied to a surface having topographical features formed therein, with gaps between those topographical features. The composition is deposited and then crosslinked in those gaps and, in some instances, over the upper surfaces or portions of those topographical features. Regardless of its shape (layer or otherwise) or use, it will be appreciated that the resulting structure is structurally stable and durable, while having desirable optical characteristics.

In some embodiments, after porogen removal it is preferred that no steps are carried out to remove or inactivate active sites (i.e., Si—O— and/or Si—OH groups) present on the crosslinked composition.

Advantageously, the final film or other structure has a very low refractive index. In some embodiments, a film formed as described herein has a refractive index of less than about 1.3, preferably less than about 1.25, and more preferably about 1.15 to about 1.25 at an average thickness of about 2,000 nm and a wavelength of about 380 nm. As used herein, “average thickness” is determined by averaging ellipsometer measurements taken at five different locations.

Moreover, the developed film or other structure has excellent optical characteristics and is good for use in many different optical applications. For example, in some embodiments, the developed film or other structure (but typically in the form of a film in this instance) has a % transmissivity of about 95% or greater, or preferably about 99% or greater, over the visible spectrum when at a thickness of about 1 micron.

When formed into a film, that film suitably has an average thickness of about 0.5 micron to about 10 microns, and preferably about 1 micron to about 3 microns. If the film is being utilized as an antireflective coating, the film will preferably have an average thickness of about one-fourth of the wavelength of the targeted light. This typically results in average thicknesses of about 50 nm to about 600 nm, preferably about 75 nm to about 450 nm, more preferably about 75 nm to about 300 nm, and even more preferably 90 nm to about 140 nm. In some embodiments, multiple application steps are carried out to achieve a thicker film.

Moreover, the nanoporous ultralow-RI films or other structures described herein are more stable and durable than those formed by prior art polystyrene/poly(methyl methacrylate) (“PS/PMMA”) nanoporous films, which leads to better durability and performance under challenging environmental conditions. For example, in some embodiments, the nanoporous film or other structure incurs substantially no change (less than about 3% change and preferably less than about 1% change) in refractive index at about 380 nm after extended baking for about 60 minutes at a temperature up to about 240° C. Similarly, in some embodiments, the nanoporous film or other structure incurs substantially no yellowing as observed under an optical microscope or via UV-Visible spectrophotometry after extended baking for about 60 minutes at a temperature up to about 240° C.

Likewise, in some embodiments, the nanoporous film or other structure incurs substantially no change in transmissivity (less than about 3% change, and preferably less than about 1% change) after extended baking for about 60 minutes at a temperature up to about 240° C., or even higher. Moreover, in some embodiments, the nanoporous film or other structure incurs no more than about 10% shrinkage after extended baking for about 60 minutes at a temperature up to about 240° C., or even higher.

Additionally or alternatively, when subjected to a stripping test, a nanoporous film formed as described herein preferably has a percent stripping of less than about 5%, more preferably less than about 1%, and even more preferably about 0%. The percent stripping can be determined by measuring the average thickness of the film as described previously. This average thickness is the initial film thickness. Next, a solvent (e.g., PGME or PGMEA) is puddled onto the film for about 30 seconds, followed by spin drying at about 3,000 rpm for about 30 seconds to remove the solvent. The average thickness is determined again by measuring at approximately the same five locations on the wafer as the locations used to determine the initial film thickness, and the averages of these measurements is the final film thickness. The amount of stripping is the difference between the initial and final film thicknesses. The percent stripping is:

$$[ 100 * \frac{Thickness before strip - Thickness after strip}{Thickness before strip} ]$$

The films formed as described herein may be subjected to high-temperature, high-humidity (HTHH) 65/90 stress test conditions of about 90H % relative humidity at about 65° C. on silicon for 500 hours. After being subjected to HTHH 65/90 conditions, the refractive index of the films changes by less than about 5%, and preferably less than about 1%, and/or the extinction coefficient changes by less than about 5%, and preferably less than about 1%.

Additional advantages of the various embodiments will be apparent to those skilled in the art upon review of the disclosure herein and the working examples below. It will be appreciated that the various embodiments described herein are not necessarily mutually exclusive unless otherwise indicated herein. For example, a feature described or depicted in one embodiment may also be included in other embodiments but is not necessarily included. Thus, the present disclosure encompasses a variety of combinations and/or integrations of the specific embodiments described herein.

As used herein, the phrase “and/or,” when used in a list of two or more items, means that any one of the listed items can be employed by itself or any combination of two or more of the listed items can be employed. For example, if a composition is described as containing or excluding components A, B, and/or C, the composition can contain or exclude A alone; B alone; C alone; A and B in combination; A and C in combination; B and C in combination; or A, B, and C in combination.

The present description also uses numerical ranges to quantify certain parameters relating to various embodiments. It should be understood that when numerical ranges are provided, such ranges are to be construed as providing literal support for claim limitations that only recite the lower value of the range as well as claim limitations that only recite the upper value of the range. For example, a disclosed numerical range of about 10 to about 100 provides literal support for a claim reciting “greater than about 10” (with no upper bounds) and a claim reciting “less than about 100” (with no lower bounds).

### EXAMPLES

The following examples set forth methods in accordance with the disclosure. It is to be understood, however, that these examples are provided by way of illustration, and nothing therein should be taken as a limitation upon the overall scope.

### Comparative Example 1

### Synthesis of Control Formulation

In a 20-ml glass vial about 4.47 g of PGMEA (Fujifilm Ultra Pure Solutions, Inc., CA), 1.57 g of PGME (Fujifilm Ultra Pure Solutions, Inc., CA), 0.45 g of trimethoxymethylsilane (Gelest, Inc., Morrisville, PA), and about 0.16 g of tetraethoxysilane (Heraeus Epurio LLC, OH) were combined. Then 2.72 g of 0.1M HNO3 (VWR International LLC, PA) were added. This mixture was mixed overnight. The formulation was spin coated on a silicon wafer at 1,000 rpm for 30 seconds and baked for about 30 minutes at 260° C. This formulation had a refractive index close to 1.45 when measured on a J. A Woollam ellipsometer.

### Example 1

### Silane Polymer Synthesis

To a 250-ml two-neck round bottom flask equipped with distillation set up and 6.8 g of phenyltrimethoxysilane (Gelest, Inc., Morrisville, PA), 1.1 g of 2-(3,4-epoxycyclohexyl)ethyl trimethoxysilane (Gelest, Inc., Morrisville, PA), 41.5 g of methyltrimethoxysilane (Gelest, Inc., Morrisville, PA), 17.9 g of tetraethoxysilane (Gelest, Inc., Morrisville, PA), 53 g propylene glycol methyl ether acetate (“PGMEA”; Ultra Pure Solutions, Inc., Castroville, CA), and 71 g of propylene glycol methyl ether (“PGME”; Ultra Pure Solutions, Inc., Castroville, CA) were combined and mixed well. Over a 10-minute period, 39.8 g of a 3N acetic acid solution (Aldrich, St Louis, MO) (17.6% acetic acid and 82.4% water) were added to the flask while stirring, followed by mixing for 10 minutes after completing the addition. The solution was heated at 97.5° C. for 4.0 hours to complete the reaction while nitrogen was on, then allowed to cool to room temperature.

### Example 2

### Formulation with Example 1 Polymer and Tetrabutylammonium Iodide

In an uncapped 20-ml glass vial, 5.7635 g of the polymer from Example 1 were added along with 3.5847 g of tetrabutylammonium iodide (Oakwood Chemical, Estill, SC), 8.05 g of butanol (Aldrich, St Louis, MO), and 0.0151 g of tetrabutylammonium fluoride (Aldrich, St Louis, MO) as a catalyst. The glass vial was capped, and the mixture was mixed on a roller for 30 minutes.

### Example 3

### Testing of Example 2 Formulation as an Ultralow-RI Film

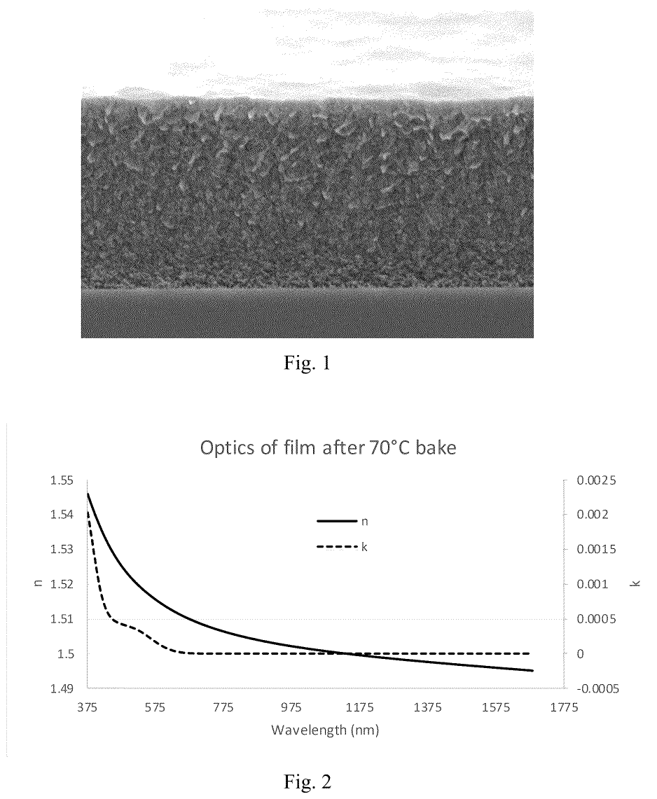

The formulation from Example 2 was spin coated on silicon wafers at 1,500 rpm for 60 seconds followed by a bake at 70° C. for 5 minutes. The resulting film had an excellent coat and yielded a refractive index of greater than 1.5 but under 1.55 at a wavelength of 375 nm with a thickness of 1.3 microns when measured using a J. A. Woollam VASE ellipsometer. See FIGS. 1 and 2.

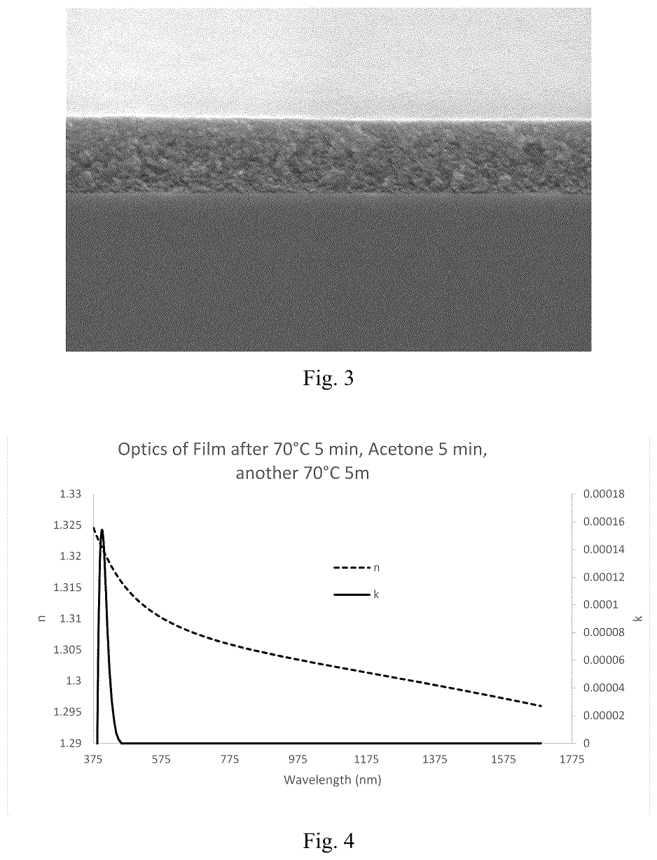

The film-coated silicon wafer was then broken into small, 1″×1″ square, film-coated chips. One of the chips was dipped and agitated in a solution of acetone (Fujifilm Ultra Pure Solutions, Carrolton, TX) for 5 minutes followed by a bake at 70° C. for 5 minutes. The refractive index of the film on this chip was under 1.325 at a wavelength of 375 nm with a thickness of 480 nm. See FIGS. 3 and 4.

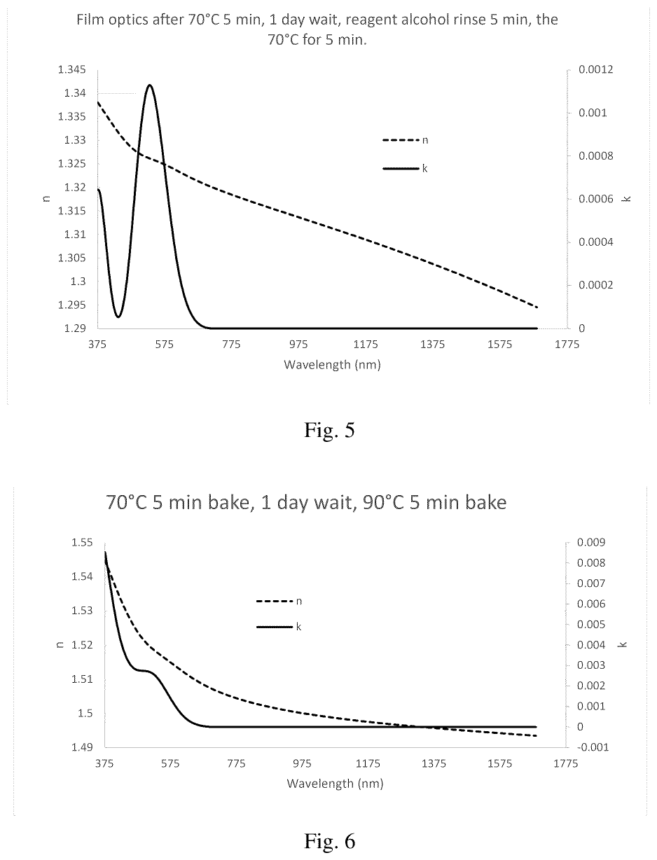

After about a day of storage, another of the film-coated chips was rinsed and agitated with reagent alcohol (Sigma Aldrich, St Louis, MO) for 5 minutes and air dried at room temperature. This film also had a refractive index of under 1.34 at a wavelength of 380 nm and a thickness of 433 nm, as shown in FIG. 5.

Two of the remaining film-coated chips were baked at 90° C. for 5 minutes after storage at room temperature for a day without being exposed to any solvents. The films on these chips still maintained a refractive index of greater than 1.5 but lower than 1.55 at a wavelength of 380 nm and a thickness of 1.3 microns, as shown in FIG. 6.

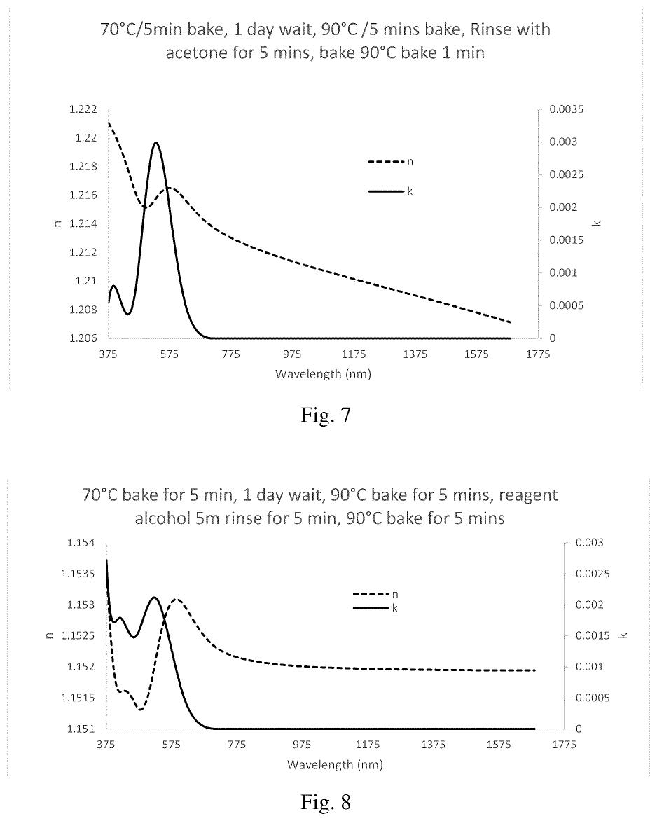

The first of these two film-coated chips was then rinsed with, and agitated in, acetone for 5 minutes followed by a 1-minute bake at 90° C., which yielded a refractive index of about 1.22 (just below 1.222) at a wavelength of 380 nm and a thickness of 635 nm, as shown in FIG. 7.

The second of these two film-coated chips was rinsed with, and agitated in, reagent alcohol for 5 minutes followed by a bake at 90° C. for 5 minutes, which yielded a refractive index of less than 1.2 (about 1.1535) at a wavelength of 380 nm and a thickness of 930 nm, as shown in FIG. 8.

### Example 4

### Formulation with Example 1 Polymer and CaCl₂

In an uncapped 20-ml glass vial, 6.3616 g of the polymer from Example 1 was combined with 3.22 g of anhydrous CaCl₂) (Aldrich, St Louis, MO), 4.98 g of DI water, and 0.053 g of tetrabutylammonium fluoride catalyst (Aldrich, St Louis, MO). The glass vial was capped, and the mixture was mixed on a roller for 30 minutes.

### Example 5

### Testing of Example 4 Formulation for Forming Ultralow-RI Film

The formulation from Example 4 was spin coated on a silicon wafer at 1,500 rpm for 60 seconds. This silicon substrate was broken into 1″×1″ square chips. One of the chips was baked at 70° C. for 5 minutes. The chip was then stored at room temperature for 1 day. This film-coated chip was then rinsed with DI water for 5 minutes. After air drying, the film on this chip showed poor coat quality. This film was hazy and rough and showed larger domains of polymer phases. Film properties were measured by ellipsometry. This film had a thickness of about 70 nm with RI<1.2 at 375 nm. The Mean Square Error (MSE) of this thin film was 27.

### Example 6

### Formulation with Example 1 Polymer and Choline Iodide

In an uncapped 20-ml glass vial, 6.36 g of polymer from Example 1 was combined with 3.01 g of choline iodide (TCI America, OR), 5.17 g of 1-butanol (Aldrich, St Louis, MO), 5.96 g of DI water, and 0.08 g of tetrabutylammonium fluoride catalyst (Aldrich, St Louis, MO). The glass vial was capped, and the mixture was mixed on a roller for 30 minutes.

### Example 7

### Testing of Example 6 Formulation for Forming Ultralow-RI Film

The formulation from Example 6 was spin coated on a silicon wafer at 1,500 rpm for 60 seconds. This wafer was broken into 1″×1″ square chips. One of the chips was baked at 70° C. for 5 minutes. The film-coated chip was then stored at room temperature for 1 day. This film-coated chip was next rinsed with DI water for 5 minutes. After air drying, the film showed poor coat quality. This film was hazy and rough and showed larger domains of polymer phases. Film properties were measured by ellipsometry. This film had a thickness of about 14 nm with RI<1.2 at 375 nm. The Mean Square Error (MSE) of this thin film was 19.

### Example 8

### Synthesis of Solgel Polymer for 70° C. Processing of Low-RI Material

In a 500-ml 3-neck flask with distillation apparatus and nitrogen flow, 15.03 g of dimethyl dimethoxysilane (Gelest, Inc., Morrisville, PA), 51.08 g of methyltrimethoxysilane (Gelest, Inc., Morrisville, PA), 30.64 g of PGMEA (Ultra Pure Solutions, Inc., Castroville, CA), and 30.01 g of PGME (Ultra Pure Solutions, Inc., Castroville, CA) were combined. A catalyst solution was made by taking 3.71 g of 0.1N nitric acid (VWR International LLC, PA) and diluting with DI water until total weight of the acid mixture was 37.20 g. This mixture was then added to the flask, and heating was started at 95° C. from room temperature for 240 minutes while stirring at 500 rpm. When tested using a moisture analyzer, the % solids of the resulting polymer solution was observed to be 42.95%.

### Example 9

### Formulation with Example 8 Polymer and 1% Tetrabutylammonium Acetate

In a 250-ml Aicello bottle, 8.0147 g of tetrabutylammonium iodide (TBAI, Oakwood Chemical, Estill, SC), 20.0121 g of 1-butanol (Aldrich, St Louis, MO), and 32.0309 g of the polymer mother liquor produced in Example 8 were mixed using a rolling mixer till homogenous. In a separate 100-ml Aicello bottle, 15.0054 g of the mixture and 0.1575 g of tetrabutylammonium acetate were mixed using a rolling mixer until homogenous.

### Example 10

### Testing of Example 9 Formulation for Forming Ultralow-RI Film at 70° C.

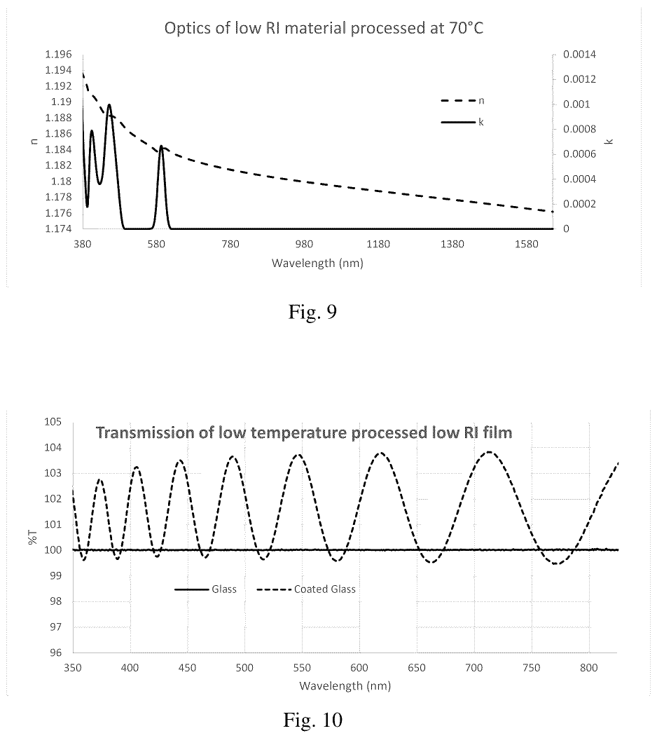

Spin coat analysis was performed on an aliquot of the formulation from Example 9 in a clean room. The solution was filtered once through a 0.2-μm PTFE filter as it was deposited onto a silicon wafer. The wafer was then spun at 1,500 rpm for 60 seconds with a 1,000 rpm/sec ramp before being baked at 70° C. for 5 minutes. After the 5-minute bake, the wafer was placed back into the spin bowl and had reagent alcohol puddled onto it for 5 minutes. After the 5 minutes, the wafer was spun at 2,000 rpm for 60 seconds with a 10,000 rpm/sec ramp before being baked a second time at 70° C. for 5 minutes. Optic properties were then measured on the JA Woollam VASE ellipsometer. This film had a thickness of about 1189 nm with an RI<1.222 at a wavelength of 375 nm. See FIG. 9.

### Example 11

Synthesis of Solgel Polymer for 70° C. Processing of Low RI Material

In a 500-ml 3-neck flask with distillation apparatus and nitrogen flow, 30.06 g of dimethyldimethoxysilane (Gelest, Inc., Morrisville, PA), 102.16 g of methyltrimethoxysilane (Gelest, Inc., Morrisville, PA), and 100 g of PGMEA (Ultra Pure Solutions, Inc., Castroville, CA) were combined. In a separate Aicello bottle, a 3N acetic acid solution was made by mixing 180 g of glacial acetic acid (Fisher Scientific Company, NJ) and 820 g of DI water. To the reaction mixture in the 3-neck flask, 74.25 g of 3N acetic acid catalyst solution was added. Once the addition of acid was complete, the mixture was heated to 115° C. from room temperature for 6 hours, stirring at 500 rpm.

### Example 12

### Formulation with Example 11 Polymer

In a 100-ml Aicello bottle, 18.0025 g of tetrabutylammonium iodide (Oakwood Chemical, Estill, SC), 30.0324 g of 1-butanol (Aldrich, St Louis, MO), 48.0217 g of polymer mother liquor from Example 11, and 0.9660 g of tetrabutylammonium acetate were combined and mixed on a rolling mixer until homogenous.

### Example 13

### Testing of Example 12 Formulation

The formulation described in Example 12 was dispensed onto Corning XG glass using a 0.2-μm PTFE filter, spin coated at 1,500 rpm for 60 seconds at 10,000 rpm/sec ramp. The wafer was then baked for 3 minutes at 90° C., rinsed with acetone for 1 minute, spun at 1,500 rpm for 60 seconds at a 10,000 rpm/sec ramp and baked for an additional minute at 90° C. Transmissivity (% T) data was collected using a UV-Vis spectrometer which was baselined using a similar uncoated Corning XG glass wafer (see FIG. 10). Haze measurements were taken using a Haze-Gard instrument after being verified by using a standard. Average haze was taken by measuring 5 points across the coating. Average haze was <0.1%.

### Example 14

### Synthesis of Solgel Polymer for Low-Temperature Gap Fill

In a 500-ml 3-neck flask with distillation apparatus and nitrogen flow, 30.06 g of dimethyldimethoxysilane (Gelest, Inc., Morrisville, PA), 102.20 g of methyltrimethoxysilane (Gelest, Inc., Morrisville, PA), 55.10 g of PGMEA (Ultra Pure Solutions, Inc., Castroville, CA), and 55.17 g of PGME (Ultra Pure Solutions, Inc., Castroville, CA) were combined. In a separate Aicello bottle, a 3N acetic acid solution was prepared by mixing 180 g of glacial acetic acid (Fisher Scientific Company, NJ) and 820 g of DI water. To the reaction mixture in the 3-neck flask, 74.27 g of the 3N acetic acid catalyst solution were added. Once the addition of the acid was complete, the mixture was heated to 115° C. from room temperature for 6 hours while stirring at 500 rpm. Using a moisture analyzer, the % solids of the resulting polymer solution was observed to be 34.20%.

### Example 15

### Formulation with Example 14 Mother Liquor

In a 20-ml glass vial, 3.0007 g of tetrabutylammonium iodide (Oakwood Chemical, Estill, SC), 0.1611 g of tetrabutylammonium acetate, 5.0001 g of 1-butanol (Aldrich, St Louis, MO), and 8.0165 g of the mother liquor described in Example 14 were combined. This mixture was then placed on a roller mixer to homogenize overnight.

### Example 16

### Testing of Example 15 Formulation for Gap Fill on 10-nm Features

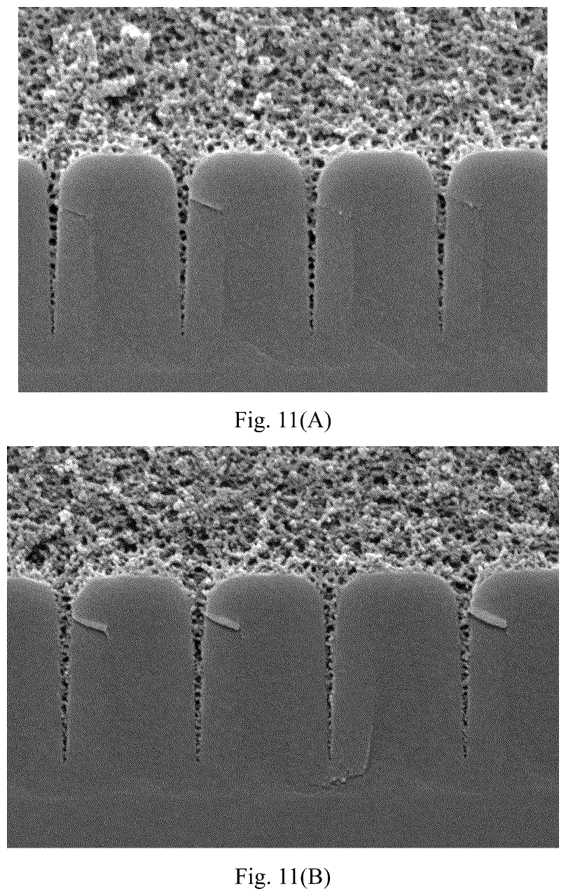

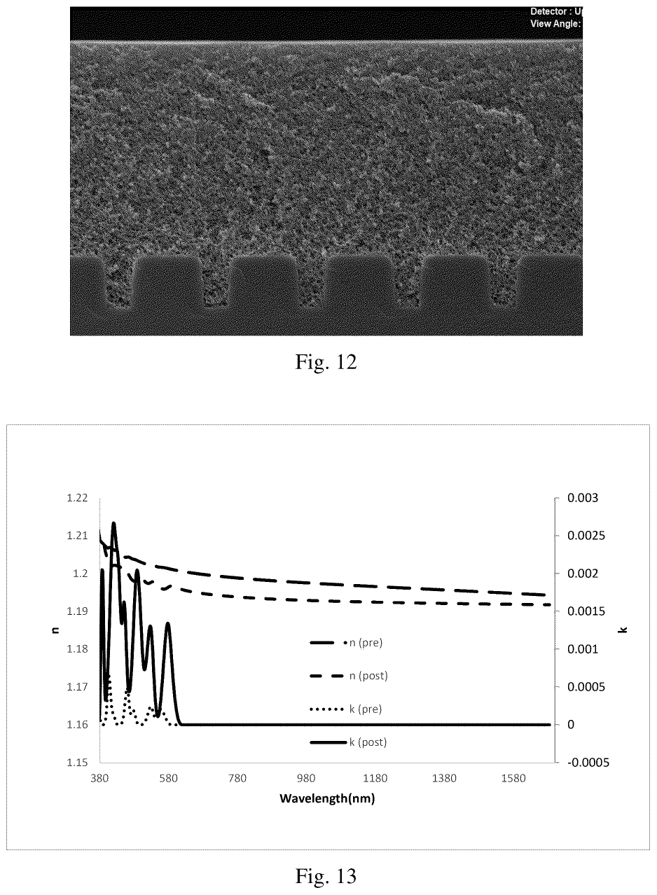

The formulation from Example 15 was coated on chips with trenches of approximately 500 nm×10 nm and 530 nm×260 nm by spin coating at 1,500 rpm for 60 seconds at 10,000 rpm/sec ramp followed by baking at either 70° C. or 90° C. for 5 minutes. The 70° C. and 90° C. chips then went through a rinse process in which acetone was puddled onto the wafers for 5 minutes and then spun off at 1,500 rpm for 60 seconds at 10,000 rpm/sec ramp. All rinsed wafers then had an additional 5-minute bake at their respective temperature. The materials showed good gap fill in both 500-nm×10-nm trenches and 530-nm×260-nm trenches as shown in FIGS. 11(A), 11 (B), and 12.

### Example 17

### Synthesis of Solgel Polymer for Highly Accelerated Stress Test After Low-Temperature Processing

To a 1-L reactor, 290.74 g of methyltrimethoxysilane (Gelest, Inc., Morrisville, PA), 85.54 g of dimethyldimethoxy silane (Gelest, Inc., Morrisville, PA), 156.42 g of PGME (Ultra Pure Solutions, Inc., Castroville, CA), and 156.40 g of PGMEA (Ultra Pure Solutions, Inc., Castroville, CA) were added. This mixture was then cooled to 15° C. under nitrogen. Once at 15° C., 110.00 g of 3N acetic acid (prepared using glacial acetic acid from Fisher Scientific Company, NJ) were added dropwise. Acid was added sufficiently slowly to ensure that the reaction temperature did not go above 20° C. Once all the acid was added, the reactor was sealed under nitrogen, and the temperature of the jacketed reactor was slowly increased to the target reaction temperature of 100° C. The reaction was stirred at 250 rpm. It took approximately 5.5 hours for the reactor to hit 100° C., after which the reaction was allowed to continue for 22 hours. The reactor was turned off, and the sample was bottled for further experimentation. When tested using a moisture analyzer, the resulting polymer solution was observed to be 36.60% solids.

### Example 18

### Formulation of Example 17 Mother Liquor for Highly Accelerated

### Stress Test After Low-Temperature Processing

In a 20-ml glass vial, 3.0041 g of tetrabutylammonium iodide (Oakwood Chemical, Estill, SC), 0.1505 g of tetrabutylammonium acetate, 5.0065 g of 1-butanol (Aldrich, St Louis, MO), and 8.0152 g of mother liquor described in Example 17 were combined. This mixture was then placed on a roller mixer to homogenize overnight.

### Example 19

### Testing of Example 18 Formulation for Highly Accelerated Stress Test After Low-Temperature Processing

The formulation from Example 18 was spin coated on silicon wafers at 1,500 rpm for 60 seconds at 10,000 rpm/sec ramp. They were then baked for 3 minutes at 90° C., puddled with acetone for 1 minute, spun at 1,500 rpm for 60 seconds at 10,000 rpm/sec ramp, and baked for 1 minute at 90° C. The material's refractive index was measured using a VASE ellipsometer. This is shown in the graph in FIG. 13, labelled as (“pre”). The wafer was also subject to conditions of 108.5° C. and 90% RH for 96 hours, and the refractive index of the material was measured again and is overlaid (labelled as “post”) in the graph shown in FIG. 13. No significant changes in refractive index were observed for the films before and after the tested conditions.

The refractive indices of the films before and after testing were also measured using a Metricon prism coupler. After completing the calibration procedures as indicated by the tool, the wafer was placed in the tool with the ramming arm set for 60 psi. The laser was aligned using the 632-nm beam to align the beam to the coupling spot. After confirmation of the successful coupling with standard deviation (SD)<0.05%, the data in Table 1 was recorded at each wavelength, before and after the completion of the testing. The results reported by the prism coupler show minimal changes in refractive index after testing conditions.

TABLE 1
Changes in Refractive Index

| Wavelength | RI | RI |
|---|---|---|
| (nm) | (Before) | (After) |
| 407 | 1.227 | 1.221 |
| 633 | 1.203 | 1.209 |
| 785 | 1.198 | 1.195 |

### Example 20

### Synthesis of Solgel Polymer for Gap Fill on Contact Holes

A first polymer solution was prepared by combining 30.06 g of dimethyldimethoxysilane (Gelest, Inc., Morrisville, PA), 102.17 g of methyltrimethoxysilane (Gelest, Inc., Morrisville, PA), 50.00 g of PGMEA (Ultra Pure Solutions, Inc., Castroville, CA), and 50.00 g of PGME (Ultra Pure Solutions, Inc., Castroville, CA) in a 500-ml 3-neck flask with distillation apparatus and nitrogen flow. In a separate Aicello bottle, a 3N acetic acid solution was prepared by mixing 180 g of glacial acetic acid (Fisher Scientific Company, NJ) and 820 g of DI water. To the reaction mixture in the 3-neck flask, 74.25 g of the 3N acetic acid catalyst solution were added. Once the addition of acid was complete, the mixture was heated to 115° C. from room temperature for 6 hours, stirring at 500 rpm. When tested with a moisture analyzer, the resulting polymer solution was observed to be 36.79% solids.

A second polymer solution was then prepared by combining 30.06 g of dimethyldimethoxysilane (Gelest, Inc., Morrisville, PA), 102.17 g of trimethoxymethylsilane (Gelest, Inc., Morrisville, PA), 50.01 g of PGMEA (Ultra Pure Solutions, Inc., Castroville, CA), and 50.00 g of PGME (Ultra Pure Solutions, Inc., Castroville, CA) in a separate 500-ml 3-neck flask with distillation apparatus and nitrogen flow. To this reaction mixture, 74.26 g of the same 3N acetic acid catalyst solution (prepared using glacial acetic acid from Fisher Scientific Company, NJ) were added. Once the addition of acid was complete, the mixture was heated to 115° C. from room temperature for 6 hours, stirring at 500 rpm. When tested with a moisture analyzer, the resulting polymer solution was observed to be 36.81% solids.

Once both polymer solutions were done reacting and cooled to room temperature, they were combined into one Aicello bottle to be used as a single solution containing both polymers for subsequent testing.

### Example 21

### Example 23 Formulation for Gap Fill on Contact Holes

To a 1-liter bottle, 322.18 g of the polymer solution from Example 20 were combined with 120.10 g of tetrabutylammonium iodide (Oakwood Chemical, Estill, SC), 6.4486 g of tetrabutylammonium acetate, and 200.11 g of 1-butanol (Aldrich, St Louis, MO). The bottle was then shaken extensively and placed on a rolling mixer to allow for homogenization overnight.

### Example 22

### Gap Fill Capabilities of Low-Temperature-Processed Films on 220 nm×1.0 μm Dense, Semi-Dense, and Isolated Vias

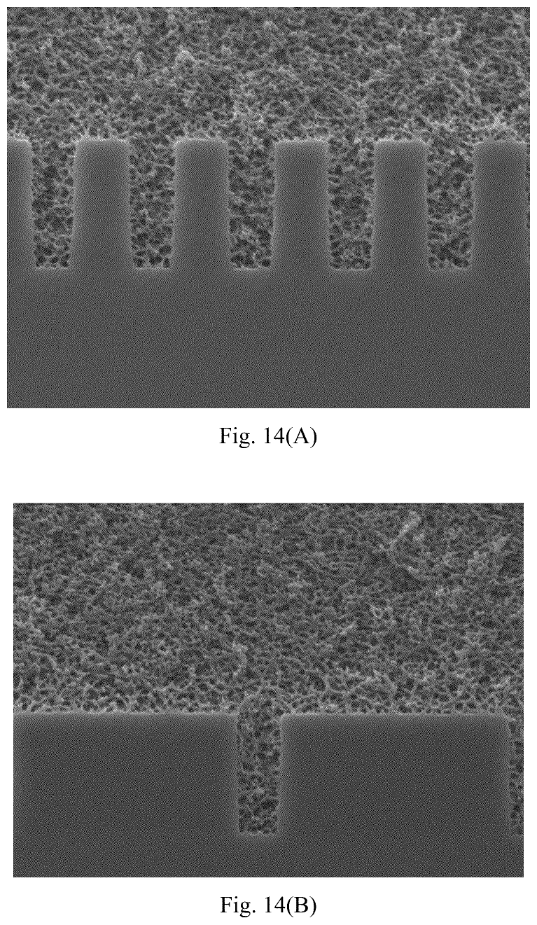

The formulation from Example 21 was spin coated on a chip containing 220-nm×1.0-μm dense, semi-dense, and isolated vias, at 1,500 rpm for 60 seconds after being endpoint filtered with a 0.1-μm PTFE filter. The chips were then baked at 90° C. for 3 minutes, followed by a cyclohexanone puddle for 1 minute, spun again at 1,500 rpm for 60 seconds, and then baked at 90° C. again for 60 seconds. The results of this experiment is shown in FIGS. 14(A) (dense vias) and 14 (B) (semi-dense vias).

### Example 23

### Testing of Example 24 Formulation Using Cyclohexanone Rinse Method

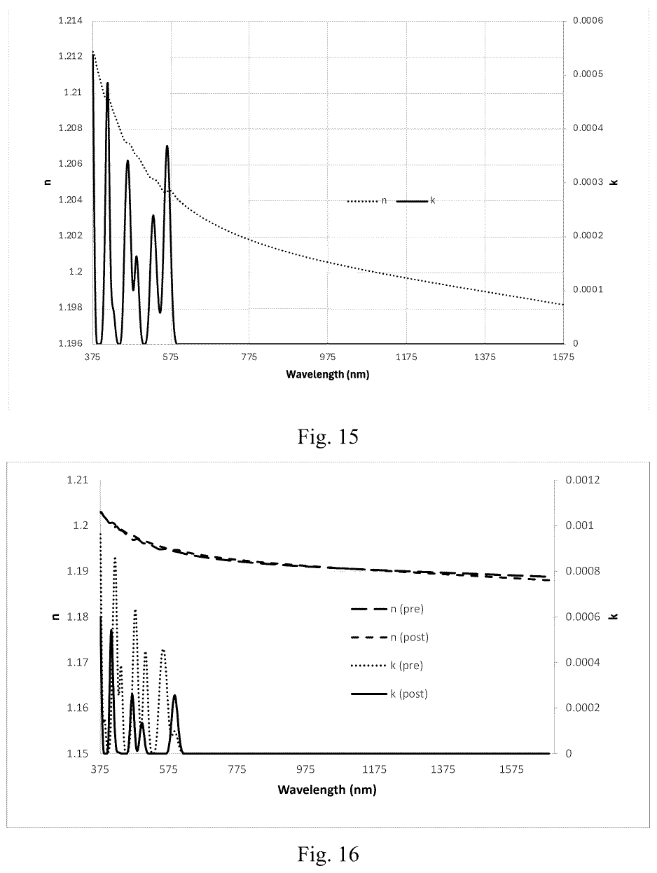

The formulation described in Example 21 was spin coated on a reclaimed silicon wafer using a 0.1-μm PTFE filter at 1,500 rpm for 60 seconds followed by bake at 90° C. for 3 minutes, followed by a cyclohexanone puddle for 1 minute, spun again at 1,500 rpm for 60 seconds, and then baked at 90° C. again for 60 seconds. Results are shown in FIG. 15. The use of cyclohexanone as an alternative solvent works similar to acetone for obtaining ultralow-RI films, without leaving rinse marks on wafers.

### Example 24

### Testing of Example 21 Formulation with High-Temperature, High-Humidity Stress Test

The formulation from Example 21 was spin coated on a silicon wafer at 1,500 rpm for 60 seconds. The wafers were then baked for 3 minutes at 90° C., puddled with cyclohexanone for 1 minute, spun at 1,500 rpm for 60 seconds, and baked for an additional minute at 90° C. The material's refractive index was measured using a VASE ellipsometer, which is shown in the graph below in FIG. 16 (labelled “pre”). The wafer was also subject to high-temperature, high-humidity (HTHH) conditions of 65° C. and 90% RH for 500 hours, and the refractive index of the material was measured again. These values were overlaid in the graph of FIG. 16 (labelled “post”). No significant changes in refractive index were observed for the films before and after the tested HTHH conditions.

The refractive indices of the films before and after HTHH testing were also measured using a Metricon prism coupler. After completing the calibration procedures as indicated by the tool, the wafer was placed in the tool with the ramming arm set for 60 psi. The laser was aligned using the 632 nm beam to align the beam to the coupling spot. After confirmation of the successful coupling with standard deviation (SD)<0.05%, the data in Table 2 was recorded at each wavelength, before and after the completion of the HTHH testing. HTHH conditions had minimal impact on the RI of the films.

TABLE 2
Refractive Index Measurements Before
and After HTHH Conditions.

| Wavelength | RI | RI |
|---|---|---|
| (nm) | (Before) | (After) |
| 407 | 1.227 | 1.207 |
| 633 | 1.203 | 1.199 |
| 785 | 1.198 | 1.196 |

### Example 25

### Synthesis of Solgel Polymer

In a 500-ml 3-neck flask with distillation apparatus and nitrogen flow, 30.06 g of dimethyldimethoxysilane (Gelest, Inc., Morrisville, PA), 102.17 g of methyltrimethoxysilane (Gelest, Inc., Morrisville, PA), 5.00 g of PGMEA (Ultra Pure Solutions, Inc., Castroville, CA), and 5.01 g of PGME (Ultra Pure Solutions, Inc., Castroville, CA) were combined. In a separate Aicello bottle, 0.01N nitric acid was prepared by combining 7.425 g of 0.1N nitric acid (VWR International LLC, PA) with 66.85 g of DI water. To the reaction mixture in the 3-neck flask, 74.27 g of the 0.01N nitric acid catalyst solution were added. Once the addition of the acid was complete, the mixture was heated to 95° C. from room temperature for 4 hours, stirring at 500 rpm.

### Example 26

### Experimentation Demonstrating Low RI Materials with UV Curability

To a 20-mL vial, 2.7152 g of the polymer described in Example 1, 0.9001 g of tetrahexyl ammonium iodide (Iofina Chemical, Covington, KY), 0.0576 g of ES-1B (San-Apro, Minato, Japan), a sulfonium salt type photoacid generator, 3.6985 g of PGME (Filtered PGME-Ultrapure (PPQ grade)), 1.9626 g of PGMEA (Filtered PGMEA-Ultrapure (PPQ grade)), and 5.6700 g of 1-Butanol (TEDIA, Fairfield, OH) were added. The formulation was placed on a roller to allow homogenization to occur at room temperature for around 20 minutes.

The solution was filtered via a 0.1 μm PTFE filter and was then spin-coated on a reclaimed silicon wafer at 1.000 RPM for 60 secs with a 10K ramp speed using an Apogee spin coater. Immediately after spinning, the resulting film was given a 10-minute broadband-UV expose step using an Oriel Sol3A UV exposure tool for 10 minutes. Next, the wafer was placed back into the spin bowl and puddled with cyclohexanone for 10 seconds. The wafer was then re-spun at the same conditions listed above and was followed by a 90° C. thermal bake for 60 seconds to allow any residual solvent to leave the system. The resultant coating was measured via a JA Woollam M2000 ellipsometer and had a thickness of 203 nm and an RI value of 1.363 at a wavelength of 380 nm

### Example 27

### Further Experimentation Demonstrating UV Curability with RI<1.2

To a 20-mL vial, 1.6945 g of the polymer described in Example 25, 0.9001 g of tetrahexyl ammonium iodide (Iofina Chemical, Covington, KY), 0.0564 g of ES-1B (San-Apro, Minato, Japan), 4.5539 g of PGME (Filtered PGME-Ultrapure (PPQ grade)), 2.1352 g of PGMEA (Filtered PGMEA-Ultrapure (PPQ grade)), and 5.6815 g of 1-Butanol (TEDIA, Fairfield, OH) were added. The formulation was placed on a roller to allow homogenization to occur at room temperature for about 20 minutes.

The resulting solution was filtered via a 0.1-μm PTFE filter and then spin-coated on a reclaimed silicon wafer at 1,000 RPM for 60 secs with a 10K ramp speed using an Apogee spin coater. This was followed by a broadband-UV exposure step of no less than 10 minutes using an Oriel Sol3A UV exposure tool. The wafer was then placed back into the spin bowl and puddled with cyclohexanone for around 10 seconds. The wafer was re-spun at the same conditions listed above and followed a 90° C. thermal bake for about 60 seconds to allow any residual solvent to leave the system. The resulting coating was measured with a JA Woollam M2000 ellipsometer and had a thickness of approximately 400 nm and an RI value of 1.17 at a wavelength of 380 nm.

1. A method of forming a nanoporous structure, the method comprising:
applying a composition to a substrate, said composition comprising a siloxane polymer and a porogen;
crosslinking said siloxane polymer to form a crosslinked composition;
contacting said crosslinked composition with a developer so as to remove said porogen and form pores in said crosslinked composition to yield the nanoporous structure.

2. The method of claim 1, wherein said crosslinking comprises heating said composition to a temperature of about 125° C. or lower.

3. The method of claim 2, wherein said temperature is about 90° C. or lower.

4. The method of claim 1, wherein said porogen is chosen from salts that are soluble in said developer.

5. The method of claim 1, wherein said porogen is chosen from ammonium salts, phosphonium salts, pyridinium salts, sulfonium salts, chloride salts, nanodomain-forming polymers, or combinations thereof.

6. The method of claim 5, wherein said porogen is chosen from quaternary alkylammonium halides comprising C₁ to C₇ alkyl groups.

7. The method of claim 1, said composition further comprising a curing catalyst that is different from said porogen.

8. The method of claim 7, wherein said curing catalyst is chosen from ammonium salts, phosphonium salts, silanes comprising amine groups, silanes comprising imidazole groups, or combinations thereof.

9. The method of claim 8, wherein said curing catalyst is chosen from tetrabutylammonium fluoride, tetrabutylammonium acetate, tetrabutylammonium iodide, tetrahexylammonium iodide, benzyltriethylammonium chloride, tetrabutylphosphonium bromide, ethyltriphenylphosphonium bromide, choline iodide, thermal acid generators, photo acid generators, radical initiators, or combinations thereof.

10. The method of claim 1, wherein said crosslinking comprises exposing said composition to UV radiation.

11. The method of claim 1, wherein said crosslinked composition is in the form of a film on said substrate.

12. The method of claim 11, wherein said film has a refractive index of about 1.3 or lower when measured at a wavelength about 380 nm.

13. The method of claim 1, wherein said substrate comprises a surface having topographical features formed therein, said topographical features having gaps therebetween and said crosslinked composition being in said gaps.

14. The method of claim 1, wherein said developer is chosen from ketones, alcohols, tetramethylammonium hydroxide, n-butyl acetate, propylene glycol methyl ether, propylene glycol methyl ether acetate, or mixtures thereof.

15. The method of claim 1, wherein said siloxane polymer comprises monomers chosen from alkoxy silanes, phenyltrimethoxysilane, acryloxypropyltrimethoxysilane, 3-glycidyloxypropyltrimethoxysilane, methacryloxypropyltrimethoxysilane, tetramethylorthosilicate, 2-(3,4-epoxycyclohexyl)ethyltrimethoxysilane, methyltrimethoxysilane, tetraethoxysilane, methyltriethoxysilane, silanes with quaternary ammonium salts, dimethyldimethoxysilane, dimethyldiethoxysilane, phenethyltrimethoxysilane, 2-(carbomethoxy)ethyltrimethoxysilane, acetoxyethyltrimethoxysilane, ethyltrimethoxysilane, n-butyltrimethoxysilane, 5,6-epoxyhexyltriethoxysilane, or combinations thereof.

16. The method of claim 1, wherein said applying is carried out about one week or longer after said composition was formed.

17. The method of claim 1, wherein said developer does not comprise a supercritical fluid.

18. A composition comprising a siloxane polymer, a porogen, and a curing catalyst that is different from said porogen.

19. The composition of claim 18, wherein said porogen is chosen from ammonium salts, phosphonium salts, pyridinium salts, sulfonium salts, chloride salts, nanodomain-forming polymers, or combinations thereof.

20. The composition of claim 19, wherein said porogen is chosen from halide quaternary alkylammonium salts comprising C₁ to C₇ alkyl groups.

21. The composition of claim 18, wherein said curing catalyst is chosen from tetrabutylammonium fluoride, tetrabutylammonium acetate, benzyltriethylammonium chloride, tetra-butyl phosphonium bromide, ethyltriphenylphosphonium bromide, tetrabutylammonium iodide tetrahexylammonium iodide, benzyltriethylammonium iodide, or combinations thereof.
